(19) United States
(12) Patent Application Publication
(10) Pub. No.: US 2026/0235240 A1
(43) Pub. Date: Aug. 13, 2026

(54) FLUID CONNECTION ASSEMBLY WITH REMOVABLE RETAINER

(71) Applicant: Oetiker NY, Inc., Lancaster, NY (US)

(72) Inventors: Andrew Jon Crane, West Chapel, FL (US); Thomas Alan Anderson, North Tonawanda, NY (US)

(21) Appl. No.: 19/154,521

(22) PCT Filed: Mar. 5, 2024
(86) PCT No.: PCT/US2024/018457

§ 371 Date: Aug. 7, 2025

Related U.S. Application Data
(60) Provisional application No. 63/489,240, filed on Mar. 9, 2023.

(51) Int. Cl. F16L 37/098

(52) U.S. Cl. CPC F16L 37/0985

(57) ABSTRACT

A fluid connection assembly including a connector body, including a first end, a second end, a first through-bore, a first radially inward facing surface including a first groove forming a first axial surface, and a first radially outward facing surface, and a retainer removably connectable to the connector body, including a second radially inward facing surface forming a flange, a third end, and a fourth end, a second radially outward facing surface, a second through-bore, at least one finger extending from the fourth end, and a second axial surface operatively arranged to engage the first axial surface to lock the retainer in the connector body.

### CROSS-REFERENCE TO RELATED APPLICATIONS

This application claims the benefit under Articles 4 and 8 of the Stockholm Act of the Paris Convention for the Protection of Industrial Property of U.S. Patent Application No. 63/489,240, filed on Mar. 9, 2023, which application is hereby incorporated by reference herein in its entirety.

### FIELD

The present disclosure relates to fluid connectors, and more particularly, to a fluid connection assembly including a retainer that decreases the insertion force required for assembly and allows for quick assembly without the need for tools.

### BACKGROUND

Fluid connectors, fluid connections, and fluid connection assemblies are integral components for many applications, and especially for automotive applications. Since an automotive system is made up of various components such as a radiator, transmission, engine, and refrigeration or coolant system, fluid must be able to travel not only within each component but also between components. An example of fluid traveling between components is the transmission fluid traveling from the transmission to the transmission oil cooler in order to lower the temperature of the transmission fluid. Fluid predominantly moves between components via flexible or rigid hoses which connect to each component by fluid connectors. Such fluid connectors typically include a retaining clip, retaining ring clip, or snap ring carried on the connector body which is adapted to snap behind a raised shoulder of a tube when the tube is fully inserted into the connector body.

However, there are many drawbacks with current designs. Current fluid connection designs require slots or apertures to be machined in the connector body such that the retaining clip can protrude therethrough and engage the tube, which requires extra post-process manufacturing. During the assembly process, installation of the retaining clip onto the connector body is difficult and failure to install the retaining clip properly can jeopardize the structural integrity of the retaining clip. The force required to engage the tube into the connector body, and overcome the radial force of the retaining clip, is very large with current designs. Since the retaining clips are very thin and small, it is easy to lose them if dropped or misplaced. Some connection assembly solutions take a long time to secure and require tools for the assembly process. An additional issue with current designs is that disassembly is difficult, SUMMARY

The present disclosure is directed to one or more exemplary embodiments of a fluid connection assembly that includes a connector body and a retainer that allows for quick assembly and disassembly, eliminates the need for post-process machining, and reduces the insertion force required to assemble the fluid connector.

The present disclosure is directed to one or more exemplary embodiments of a fluid connection assembly.

In an exemplary embodiment, the fluid connection assembly comprises a connector body, including a first end, a second end, a first through-bore, a first radially inward facing surface including a first groove forming a first axial surface, and a first radially outward facing surface, and a retainer removably connectable to the connector body, including a second radially inward facing surface forming a flange, a third end, and a fourth end, a second radially outward facing surface, a second through-bore, at least one finger extending from the fourth end, and a second axial surface operatively arranged to engage the first axial surface to lock the retainer in the connector body.

In an exemplary embodiment, the at least one finger comprises a proximal end connected to the fourth end, a distal end, a third radially outward facing surface, and a third radially inward facing surface, wherein the third radially inward facing surface is a frusto-conical surface arranged at an acute angle with respect to the second radially inward facing surface. In an exemplary embodiment, a second groove is formed in the third radially outward facing surface, wherein the second groove forms the second axial surface. In an exemplary embodiment, the distal end forms the second axial surface. In an exemplary embodiment, at least one of the second radially outward facing surface and the third radially outward facing surface is a frusto-conical surface arranged at an acute angle with respect to the second radially inward facing surface.

In an exemplary embodiment, the third radially outward facing surface comprises a frusto-conical surface, and at least one constant diameter surface. In an exemplary embodiment, the at least one constant diameter surface comprises a first constant diameter surface, and a second constant diameter surface, spaced apart from the first constant diameter surface. In an exemplary embodiment, the second constant diameter surface is arranged at the distal end. In an exemplary embodiment, the first constant diameter surface comprises a first diameter, the second constant diameter surface comprises a second diameter, and the second diameter is greater than the first diameter.

In an exemplary embodiment, the retainer comprises a first section including a first protrusion and a first hole, a second section including a second protrusion and a second hole, wherein the first protrusion and the second protrusion are operatively arranged to engage the first hole and the second hole, respectively, to connect the first section to the second section to form the retainer. In an exemplary embodiment, at least one of the first protrusion and the second protrusion comprises at least one tooth. In an exemplary embodiment, at least one of the first protrusion and the second protrusion comprises a shoulder.

In an exemplary embodiment, the fluid connection assembly further comprises a tube including a fourth radially outward facing surface comprising a second groove, wherein the flange is operatively arranged to engage the second groove to secure the tube in the connector body. In an exemplary embodiment, the tube further comprises a third groove and a seal arranged therein. In an exemplary embodiment, when the tube is secured to the connector body via the retainer, a radial space is arranged between the fourth radially outward facing surface and the third radially inward facing surface. In an exemplary embodiment, the at least one finger comprises a plurality of fingers circumferentially spaced about the fourth end.

The present disclosure is directed to one or more exemplary embodiments of a fluid connection assembly.

In an exemplary embodiment, the fluid connection assembly comprises a connector body, including a first end, a second end, a first through-bore, a first radially inward facing surface including a first groove forming a first axial surface, and a first radially outward facing surface, a retainer removably connectable to the connector body, including a second radially inward facing surface forming a flange, a third end, and a fourth end, a second radially outward facing surface, a second through-bore, a plurality of fingers extending from and circumferentially spaced about the fourth end, and a second axial surface operatively arranged to engage the first axial surface to lock the retainer in the connector body, and a tube including a third radially outward facing surface comprising a second groove, wherein the flange is operatively arranged to engage the second groove to secure the tube in the connector body.

In an exemplary embodiment, each finger of the plurality of fingers comprises a proximal end connected to the fourth end, a distal end, a fourth radially outward facing surface, and a third radially inward facing surface, wherein the third radially inward facing surface is a frusto-conical surface arranged at an acute angle with respect to the second radially inward facing surface. In an exemplary embodiment, when the tube is secured to the connector body via the retainer, a radial space is arranged between the third radially outward facing surface and the third radially inward facing surface. In an exemplary embodiment, the retainer comprises a first section including a first protrusion and a first hole, and a second section including a second protrusion and a second hole, wherein the first protrusion and the second protrusion are operatively arranged to engage the first hole and the second hole, respectively, to connect the first section to the second section to form the retainer. In an exemplary embodiment, at least one of the first protrusion and the second protrusion comprises at least one tooth. In an exemplary embodiment, at least one of the first protrusion and the second protrusion comprises a shoulder.

The present disclosure is directed to one or more exemplary embodiments of a fluid connection assembly that offers a fast, ergonomic, toolless fluid connection type. In an exemplary embodiment, the fluid connection assembly comprises a connector body and a retainer. The retainer may comprise a polymer and requires a low insertion force for connection of a tube to the connector body. Such low insertion force allows for better ergonomic hand and body position for assemblers. In an exemplary embodiment, the tube is roll formed. In an exemplary embodiment, all sealing and retaining components are arranged on the tube prior to inserting the tube into the connector body. In an exemplary embodiment, the connector body can be brazed on without destroying or damaging the retaining or sealing components of the fluid connection assembly.

In an exemplary embodiment, the fluid connection assembly offers tamperproof disconnection protection, wherein the retainer comprises a plurality of legs all of which must be compressed simultaneously to remove the retainer from the connector body. In an exemplary embodiment, a tool can be used to compress all of the legs at once to remove the retainer from the connector body. In an exemplary embodiment, the fluid connection assembly can be assembled and disassembled a plurality of times without damaging the retaining and sealing components.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is a front perspective view of a fluid connection assembly.

FIG. 2 is a front perspective exploded view of the fluid connection assembly shown in FIG. 1.

FIG. 3A is a front perspective view of the retainer shown in FIG. 1.

FIG. 3B is a rear perspective view of the retainer shown in FIG. 1.

FIG. 4A is a rear perspective view of the retainer section shown in FIG. 1.

FIG. 4B is a front perspective view of the retainer section shown in FIG. 1.

FIG. 5 is a cross-sectional view of the fluid connection assembly taken generally along line 5-5 in FIG. 1.

FIG. 6 is a front perspective view of a fluid connection assembly.

FIG. 7 is a front perspective exploded view of the fluid connection assembly shown in FIG. 6.

FIG. 8A is a front perspective view of the retainer shown in FIG. 6.

FIG. 8B is a rear perspective view of the retainer shown in FIG. 6.

FIG. 9A is a rear perspective view of the retainer section shown in FIG. 6.

FIG. 9B is a front perspective view of the retainer section shown in FIG. 6.

FIG. 10 is a cross-sectional view of the fluid connection assembly taken generally along line 10-10 in FIG. 6.

FIG. 11 is a cross-sectional view of the fluid connection assembly taken generally along line 11-11 in FIG. 6.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

It should be appreciated that the term “tube” as used herein is synonymous with hose, pipe, channel, conduit, tube end form, or any other suitable pipe flow used in hydraulics and fluid mechanics. It should further be appreciated that the term “tube” can mean a rigid or flexible conduit of any material suitable for containing and allowing the flow of a gas or a liquid.

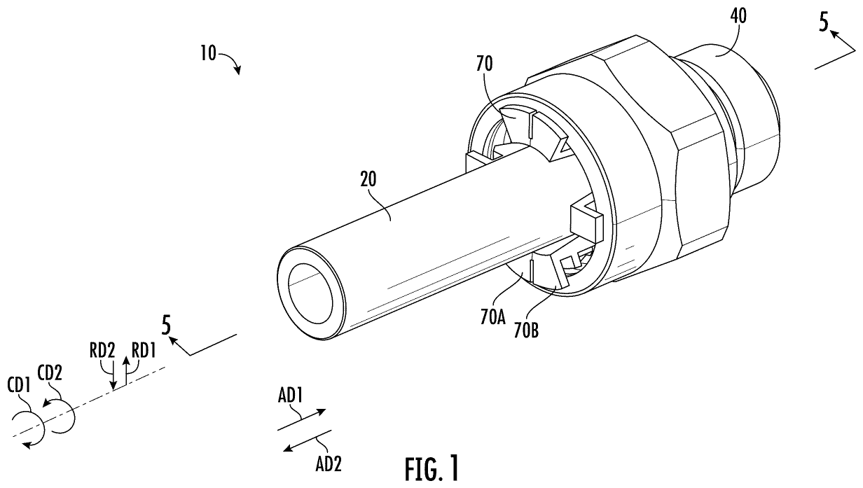

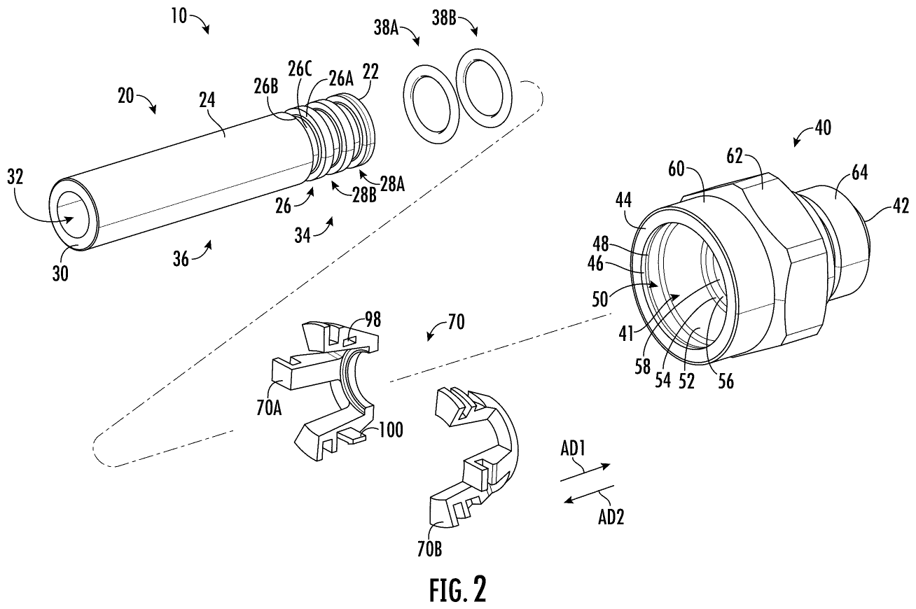

Adverting now to the figures, FIG. 1 is a front perspective view of fluid connection assembly 10. FIG. 2 is a front perspective exploded view of fluid connection assembly 10. Fluid connection assembly 10 generally comprises connector body 40 and retainer 70. In an exemplary embodiment, fluid connection assembly 10 further comprises tube 20.

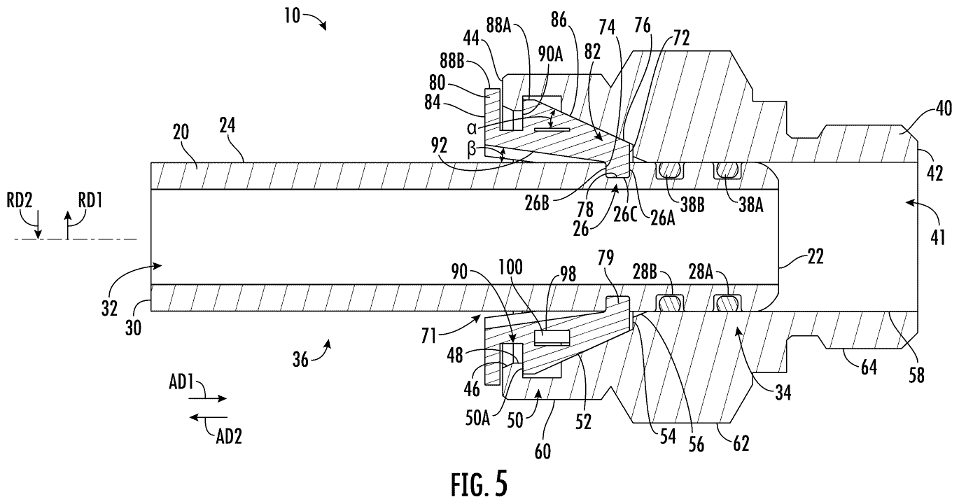

Tube 20 comprises end 22, section 34, groove 26, section 36, end 30, and through-bore 32. Through-bore 32 extends through tube 20 from end 22 to end 30. Section 34 is arranged between end 22 and groove 26 and comprises radially outward facing surface 24. Radially outward facing surface 24 includes a substantially constant diameter. In an exemplary embodiment, radially outward facing surface 24 comprises a frusto-conical taper or curvilinear surface proximate end 22 (see FIG. 5).

Groove 26 is arranged between section 34 and section 36 and comprises surface 26A, surface 26B, and surface 26C. In an exemplary embodiment, surface 26A is an axial surface facing at least partially in axial direction AD2 and surface 26B is an axial surface facing at least partially in axial direction AD1. In an exemplary embodiment, surface 26C is a radially outward facing surface. In an exemplary embodiment, tube 20 may comprise a radially outward protruding shoulder instead of or in addition to groove 26. In an exemplary embodiment, and as shown, groove 26 is arranged between and spaced apart from end 22 and end 30. Section 36 is arranged between groove 26 and end 30. In an exemplary embodiment, tube 20 further comprises one or more sealing grooves, for example grooves 28A-28B, operatively arranged to at least partially enclose seals, for example, seals 38A-38B. Seals 38A-38B are arranged in grooves 28A-28B to create a fluid-tight seal between tube 20 and connector body 40. In an exemplary embodiment, the small circle diameter of seal 38A, 38B is greater than the depth of groove 28A, 28B such that seal 38A, 38B protrudes radially outward from radially outward facing surface 24.

Tube 20 is arranged to be inserted, specifically with end 22 first, into connector body 40. Tube 20 is inserted into connector body 40 until section 34 engages radially inward facing surface 58 and retainer 70 snaps into and/or engages groove 26. Seals 38A and 38B sealingly engage radially inward facing surface 58 to form a fluid-tight seal between tube 20 and connector body 40 (see FIG. 5). It should be appreciated that tube 20 may be any traditional tube or tube end form comprising a bead, radially outward extending protrusion or flange, or ramp profile, which extends radially outward and axially on the outer surface of the tube, to secure the tube within the connector body. In an exemplary embodiment, tube 20 comprises at least one of a metal, polymer, and ceramic. In an exemplary embodiment, tube 20 comprises a metal and is roll formed.

Connector body 40 comprises end 42, end 44, through-bore 41 extending from end 42 to end 44, one or more radially inward facing surfaces, for example, radially inward facing surface 48, radially inward facing surface 52, and radially inward facing surface 58, and one or more radially outward facing surfaces, for example, radially outward facing surface 60 and radially outward facing surface 64. Radially inward facing surface 48 extends from end 44 in axial direction AD1. In an exemplary embodiment, radially inward facing surface 48 comprises a constant diameter. Radially inward facing surface 48 comprises annular groove 50 forming a radially inward facing surface and two axial surfaces. Annular groove 50, and in particular axial surface 50A of annular groove 50 facing in axial direction AD1, is arranged to engage surface 90A of groove 90 to secure retainer 70 in connector body 40, as will be described in greater detail below. In an exemplary embodiment, radially inward facing surface 48 is connected to end 44 via radially inward facing surface 46. Radially inward facing surface 46 is a frusto-conical surface extending radially outward in axial direction AD2. Radially inward facing surface 46 facilitates alignment and connection of retainer 70 as it is being connected to connector body 40.

Radially inward facing surface 48 is connected to radially inward facing surface 52. Radially inward facing surface 52 is a frusto-conical surface extending radially outward in axial direction AD2. In an exemplary embodiment, radially inward facing surface 52 corresponds to radially outward facing surface 76 and/or radially outward facing surface 86 (i.e., radially inward facing surface 52 is arranged at angle α with respect to radially inward facing surface 58). Radially inward facing surface 52 is connected to radially inward facing surface 58 via surface 54. Surface 54 is an axial surface facing substantially in axial direction AD2. In an exemplary embodiment, radially inward facing surface 58 is connected to axial surface 54 via radially inward facing surface 56. Radially inward facing surface 56 is a frusto-conical surface extending radially outward in axial direction AD2. Radially inward facing surface 56 facilitates alignment and connection of retainer 70 as it is being connected to connector body 40. Radially inward facing surface 58 extends from end 42. In an exemplary embodiment, radially inward facing surface 58 comprises a constant diameter. In an exemplary embodiment, radially inward facing surface 48 has a greater diameter than the diameter of radially inward facing surface 58.

Radially outward facing surface 60 extends from end 44. Radially outward facing surface 64 extends from end 42. Head 62 is arranged axially between radially outward facing surface 60 and radially outward facing surface 64. In an exemplary embodiment, the diameter of radially outward facing surface 60 is greater than the diameter of radially outward facing surface 64. In an exemplary embodiment, an annular notch or groove is axially arranged between radially outward facing surface 60 and head 62. In an exemplary embodiment, an annular groove is axially arranged between radially outward facing surface 64 and head 62, wherein the annular groove is arranged to engage and/or at least partially enclose a seal. It should be appreciated that the various radially outward facing surfaces may comprise constant diameters or variable diameters.

Connector body 40 is arranged to be connected to a component that is filled with a fluid. For example, connector body 40 may be connected to a transmission via radially outward facing surface 64 (e.g., via threading, brazing, adhesives, welding, etc.). Connector body 40 may be screwed into a threaded hole in the transmission via head 62 (e.g., using a wrench), which is then filled with transmission fluid. In an exemplary embodiment, head 62 is hexagonal; however, it should be appreciated that the head may comprise any geometry suitable for applying torque to connector body 40. It should also be noted that, in an exemplary embodiment, connector body 40 may also be used for an inline connection within a line set. Another component in which fluid connection assembly 10, specifically connector body 40, may be installed into is an engine block. It should be appreciated that fluid connection assembly 10 may be used in various other components, assemblies, and subassemblies in which fluid connection is desired. In an exemplary embodiment, connector body 40 comprises at least one of a metal, a polymer, and a ceramic.

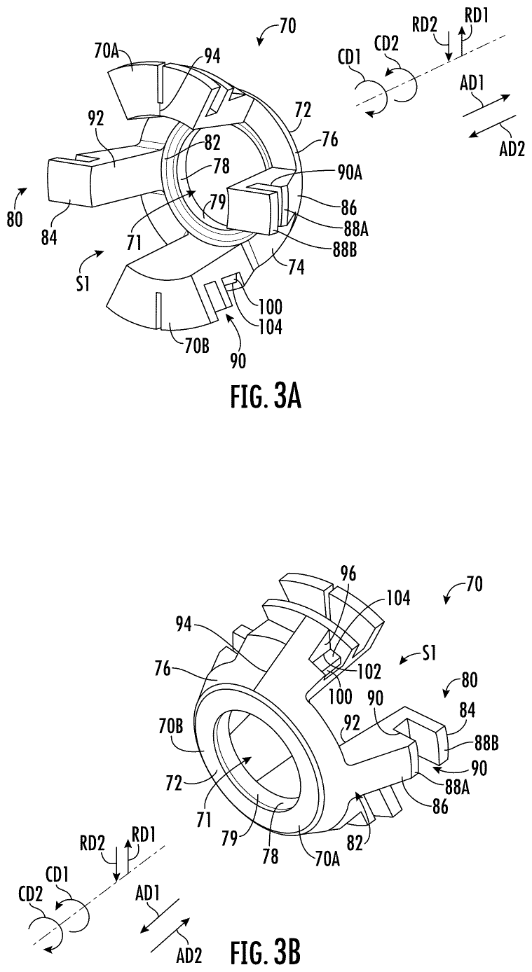

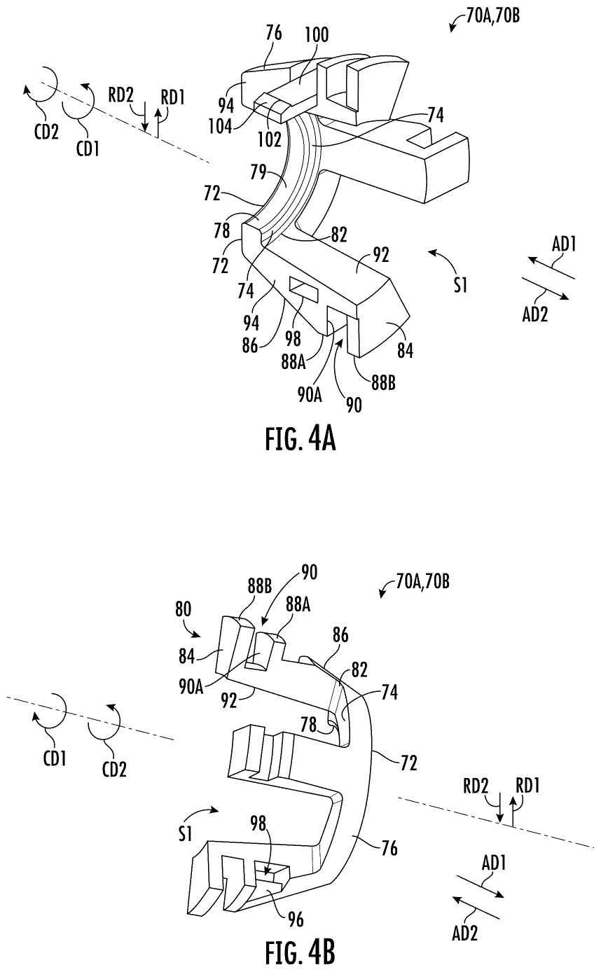

FIG. 3A is a front perspective view of retainer 70. FIG. 3B is a rear perspective view of retainer 70. FIG. 4A is a rear perspective view of retainer section 70A, 70B. FIG. 4B is a front perspective view of retainer section 70A, 70B. FIG. 5 is a cross-sectional view of fluid connection assembly 10 taken generally along line 5-5 in FIG. 1. Retainer 70 is operatively arranged to be removably connected to connector body 40 and comprises end 72, end or surface 74, through-bore 71, radially outward facing surface 76, radially inward facing surface 78, and one or more fingers 80.

End 72 comprises an axial surface facing generally in axial direction AD1. End 72 is operatively arranged to engage or be arranged proximate to surface 54 when retainer 70 is connected to connector body 40. In an exemplary embodiment, and as shown, radially outward facing surface 76 is a frusto-conical surface extending radially outward in axial direction AD2. Radially outward facing surface 76 may correspond to radially outward facing surface 86, forming a single frusto-conical surface arranged at angle α with respect to radially inward facing surface 78. In an exemplary embodiment, radially inward facing surface 78 comprises a constant diameter and forms flange 79 arranged to engage groove 24 to secure tube 20 to connector body 40. Specifically, when tube 20 is secured to connector body 40 by retainer 70, surface 72 is arranged to engage or proximate to surface 26A, surface 74 is arranged to engage or proximate to surface 26B, and radially inward facing surface 78 is arranged to engage or proximate to radially outward facing surface 26C.

Each of fingers 80 comprises end 82 connected to end 74, end 84, radially outward facing surface 86, and radially inward facing surface 92. In an exemplary embodiment, and as shown, radially outward facing surface 86 is a frusto-conical surface extending radially outward in axial direction AD2. Radially outward facing surface 86 is arranged at angle α with respect to radially inward facing surface 78. In an exemplary embodiment, angle α is an acute angle, for example, 25 degrees. When retainer 70 is connected to connector body 40, radially outward facing surface 86 and/or radially outward facing surface 76 is arranged to engage or proximate to radially inward facing surface 52. The engagement of radially outward facing surface 76, 86 with radially inward facing surface 52 and/or end 72 with surface 54 prevents axial displacement of retainer 70 in direction AD1 with respect to connector body 40. Moreover, the frusto-conical nature of corresponding surface 52 and surface 76, 86 facilitates alignment and connection of retainer 70 as it is being connected to connector body 40.

In an exemplary embodiment, finger 80 further comprises radially outward facing surface 88A and/or radially outward facing surface 88B. Radially outward facing surface 88A comprises a constant diameter and is connected to radially outward facing surface 86. Radially outward facing surface 88B comprises a constant diameter and is connected to end 84. In an exemplary embodiment, the diameter of radially outward facing surface 88B is greater than the diameter of radially outward facing surface 88A. Finger 80 further comprises groove 90. Groove 90 is an annular groove extending radially inward into finger 80. In an exemplary embodiment, and as shown, groove 90 is axially arranged between radially outward facing surface 88A and radially outward facing surface 88B. However, it should be appreciated that, in an exemplary embodiment, groove 90 is arranged in radially outward facing surface 86. Groove 90 forms surface 90A, which is operatively arranged to engage surface 50A when retainer 70 is connected to connector body 40. In an exemplary embodiment, surface 90A is an axial surface facing substantially in axial direction AD2.

Radially inward facing surface 92 is a frusto-conical surface extending radially outward in axial direction AD2. Radially inward facing surface 92 is arranged at angle 3 with respect to radially inward facing surface 78, or radially outward facing surface 24 of tube 20. In an exemplary embodiment, angle β is an acute angle, for example, 8 degrees. In an exemplary embodiment, angle α is greater than angle β. The frusto-conical nature of radially inward facing surface 92 results in a radial space being arranged between fingers 80 and tube 20. This space allows fingers 80 to be displaced radially inward in radial direction RD2 to disengage surfaces 90A from surfaces 50A, such that retainer 70, and tube 20, can be removed from connector body 40.

Fingers 80 are circumferentially spaced apart, for example, by spaces S1. In an exemplary embodiment, retainer 70 comprises a plurality of fingers 80, for example four fingers 80. As previously described, fingers 80 facilitate the removal of retainer 70 from connector body. For example, a user may displace fingers 80, via ends 84 and/or radially outward facing surfaces 88B, radially inward to disengage surfaces 90A from surface 50A, at which point retainer 70 can be removed from connector body 40.

In an exemplary embodiment, retainer 70 comprises a plurality of sections, for example, section 70A and section 70B. In an exemplary embodiment, section 70A and section 70B are substantially the same and thus are described herein as having substantially the same components. In addition to the elements described above, section 70A, 70B comprises planar surface 94, hole 98, and protrusion 100. As shown, retainer 70 is substantially split in half at surface 94. Specifically, section 70A is mated to section 70B at respective surfaces 94. Protrusion 100 of section 70A is arranged to engage hole 98 of section 70B and protrusion 100 of section 70B is arranged to engage hole 98 of section 70A.

Hole 98 extends from surface 94 to surface 96. In an exemplary embodiment, surface 96 is arranged parallel to surface 94. Protrusion 100 comprises shoulder 102. When sections 70A and 70B are connected to form retainer 70, surfaces 94 of sections 70A-70B are engaged, protrusions 100 extend through respective holes 98, and shoulders 102 engage respective surfaces 96 thereby preventing disconnection of section 70B from section 70A. In an exemplary embodiment, protrusion 100 further comprises tapered surface 104. Tapered surface 104 facilitates alignment and connection of sections 70A-70B as protrusions 100 are being inserted into respective holes 98.

In an exemplary embodiment, each of sections 70A-70B comprises a plurality of fingers 80, for example three fingers 80. A first finger 80 comprises protrusion 100 and a second finger 80 comprises hole 98. A third finger 80 is arranged circumferentially between and spaced apart from the first finger 80 and the second finger 80. When sections 70A-70B are connected, the first finger 80 of section 70A abuts the second finger of section 70B, and the second finger of section 70A abuts the first finger of section 70B. Thus, it could be said that retainer 70 comprises six fingers, or four circumferentially spaced fingers.

To assemble fluid connection assembly 10, section 70A and section 70B are arranged about tube 20 such that radially inward facing surfaces 78 are substantially aligned with radially outward facing surface 26C and protrusions 100 are aligned with holes 98. Section 70B is connected to section 70A around tube 20. Specifically, and as previously described, protrusions 100 are engaged with respective holes 98 until shoulders 102 engage respective surfaces 96. Radially inward facing surface 78 is engaged with groove 26 and tube 20 extends through retainer 70. In an exemplary embodiment, seals 38A-38B are arranged in grooves 28A-28B. Tube 20, with retainer 70 arranged thereon, is then inserted, with end 22 first into connector body 40 in axial direction AD1 until section 34 engages radially inward facing surface 58, end 72 engages surface 54, and/or radially outward facing surface 76, 86 engages radially inward facing surface 52. The engagement of radially outward facing surface 86 with radially inward facing surface 48 forces fingers 80 radially inward until surface 90A aligns with groove 50, at which point fingers 80 snap back radially outward to their original position. Surface 90A is then engaged with surface 50A to prevent displacement of retainer 70 in axial direction AD2 with respect to connector body 40.

To disassemble fluid connection assembly 10, fingers 80 are displaced radially inward, such that angle β is decreased, until surfaces 90A disengage surface 50A. Retainer 70 and tube 20 may then be removed from connector body 40. If desired, retainer 70 can be removed from tube 20, for example by displacing protrusions 100 to disengage shoulders 102 from respective surfaces 96, at which point section 70B can be removed from section 70A.

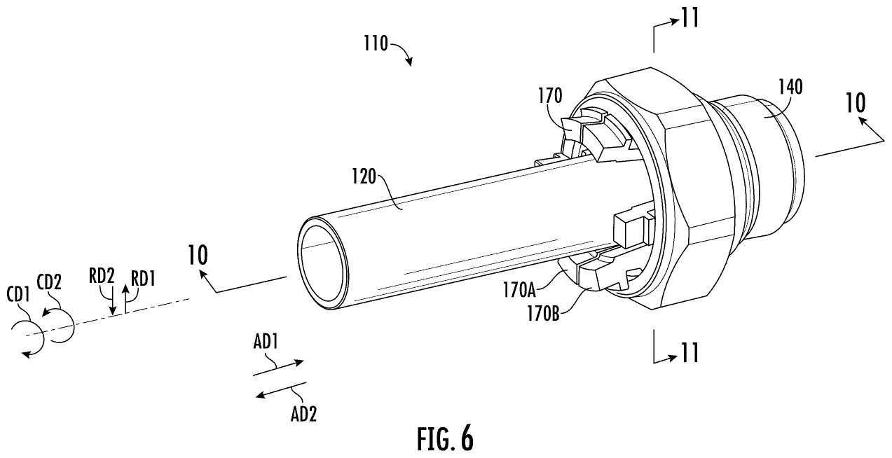

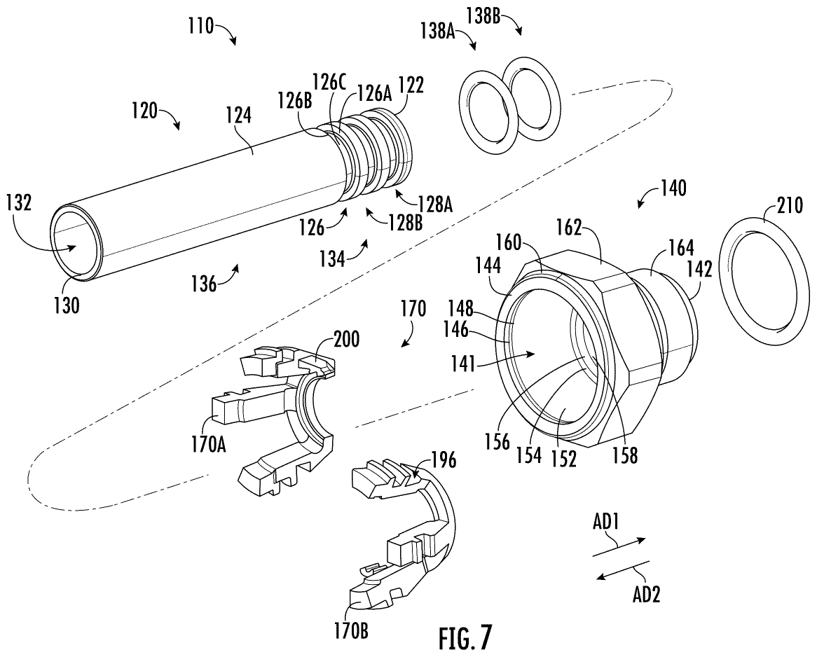

FIG. 6 is a front perspective view of fluid connection assembly 110. FIG. 7 is a front perspective exploded view of fluid connection assembly 110. Fluid connection assembly 110 generally comprises connector body 140 and retainer 170. In an exemplary embodiment, fluid connection assembly 110 further comprises tube 120.

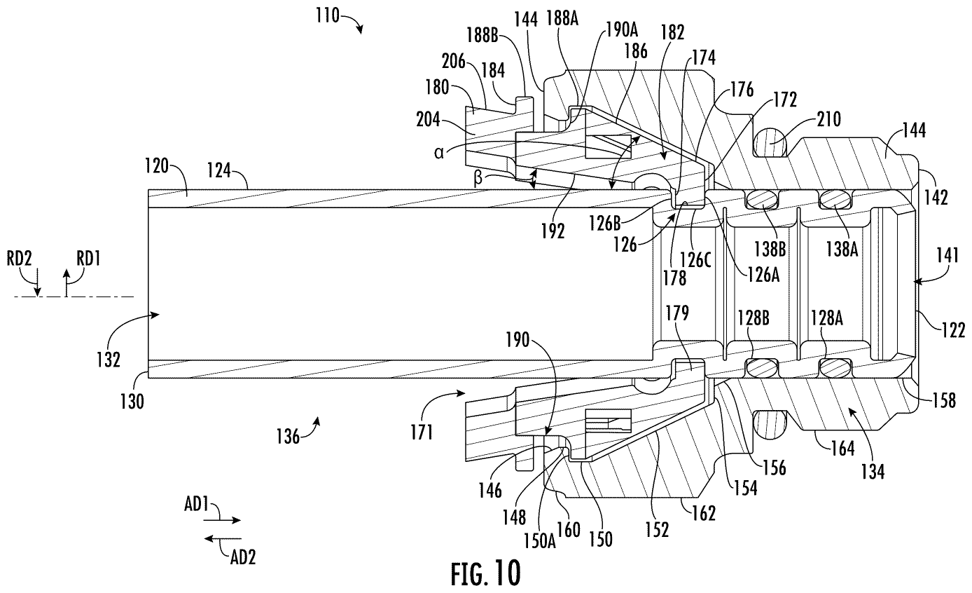

Tube 120 comprises end 122, section 134, groove 126, section 136, end 130, and through-bore 132. Through-bore 132 extends through tube 120 from end 122 to end 130. Section 134 is arranged between end 122 and groove 126 and comprises radially outward facing surface 124. Radially outward facing surface 124 includes a substantially constant diameter. In an exemplary embodiment, radially outward facing surface 124 comprises a frusto-conical taper or curvilinear surface proximate end 122 (see FIG. 10).

Groove 126 is arranged between section 134 and section 136 and comprises surface 126A, surface 126B, and surface 126C. In an exemplary embodiment, surface 126A is an axial surface facing at least partially in axial direction AD2 and surface 126B is an axial surface facing at least partially in axial direction AD1. In an exemplary embodiment, surface 126C is a radially outward facing surface. In an exemplary embodiment, tube 120 may comprise a radially outward protruding shoulder instead of or in addition to groove 126. In an exemplary embodiment, and as shown, groove 126 is arranged between and spaced apart from end 122 and end 130. Section 136 is arranged between groove 126 and end 130. In an exemplary embodiment, tube 120 further comprises one or more sealing grooves, for example grooves 128A-128B, operatively arranged to at least partially enclose seals, for example, seals 138A-138B. Seals 138A-138B are arranged in grooves 128A-128B to create a fluid-tight seal between tube 120 and connector body 140. In an exemplary embodiment, the small circle diameter of seal 138A, 138B is greater than the depth of groove 128A, 28B such that seal 138A, 138B protrudes radially outward from radially outward facing surface 124.

Tube 120 is arranged to be inserted, specifically with end 122 first, into connector body 140. Tube 120 is inserted into connector body 140 until section 134 engages radially inward facing surface 158 and retainer 170 snaps into and/or engages groove 126. Seals 138A and 138B sealingly engage radially inward facing surface 158 to form a fluid-tight seal between tube 120 and connector body 140 (see FIG. 10). It should be appreciated that tube 120 may be any traditional tube or tube end form comprising a bead, radially outward extending protrusion or flange, or ramp profile, which extends radially outward and axially on the outer surface of the tube, to secure the tube within the connector body. In an exemplary embodiment, tube 120 comprises at least one of a metal, polymer, and ceramic. In an exemplary embodiment, tube 120 comprises a metal and is roll formed.

Connector body 140 comprises end 142, end 144, through-bore 141 extending from end 142 to end 144, one or more radially inward facing surfaces, for example, radially inward facing surface 148, radially inward facing surface 152, and radially inward facing surface 158, and one or more radially outward facing surfaces, for example, radially outward facing surface 160 and radially outward facing surface 164. Radially inward facing surface 148 extends from end 144 in axial direction AD1. In an exemplary embodiment, radially inward facing surface 148 comprises a constant diameter. Radially inward facing surface 148 comprises annular groove 150 forming a radially inward facing surface and two axial surfaces. Annular groove 150, and in particular axial surface 150A of annular groove 150 facing in axial direction AD1, is arranged to engage surface 190A of groove 190 to secure retainer 170 in connector body 140, as will be described in greater detail below. In an exemplary embodiment, radially inward facing surface 148 is connected to end 144 via radially inward facing surface 146. Radially inward facing surface 146 is a frusto-conical surface extending radially outward in axial direction AD2. Radially inward facing surface 146 facilitates alignment and connection of retainer 170 as it is being connected to connector body 140.

Radially inward facing surface 148 is connected to radially inward facing surface 152. Radially inward facing surface 152 is a frusto-conical surface extending radially outward in axial direction AD2. In an exemplary embodiment, radially inward facing surface 152 corresponds to radially outward facing surface 176 and/or radially outward facing surface 186 (i.e., radially inward facing surface 152 is arranged at angle α with respect to radially inward facing surface 158). Radially inward facing surface 152 is connected to radially inward facing surface 158 via surface 154. Surface 154 is an axial surface facing substantially in axial direction AD2. In an exemplary embodiment, radially inward facing surface 158 is connected to axial surface 154 via radially inward facing surface 156. Radially inward facing surface 156 is a frusto-conical surface extending radially outward in axial direction AD2. Radially inward facing surface 156 facilitates alignment and connection of retainer 170 as it is being connected to connector body 140. Radially inward facing surface 158 extends from end 142. In an exemplary embodiment, radially inward facing surface 158 comprises a constant diameter. In an exemplary embodiment, radially inward facing surface 148 has a greater diameter than the diameter of radially inward facing surface 158.

Radially outward facing surface 160 extends from end 144. Radially outward facing surface 164 extends from end 142. Head 162 is arranged axially between radially outward facing surface 160 and radially outward facing surface 164. In an exemplary embodiment, the diameter of radially outward facing surface 160 is greater than the diameter of radially outward facing surface 164. In an exemplary embodiment, an annular groove is axially arranged between radially outward facing surface 164 and head 162, wherein the annular groove is arranged to engage and/or at least partially enclose seal 210. It should be appreciated that the various radially outward facing surfaces may comprise constant diameters or variable diameters.

Connector body 140 is arranged to be connected to a component that is filled with a fluid. For example, connector body 140 may be connected to a transmission via radially outward facing surface 164 (e.g., via threading, brazing, adhesives, welding, etc.). Connector body 140 may be screwed into a threaded hole in the transmission via head 162 (e.g., using a wrench), which is then filled with transmission fluid. In an exemplary embodiment, head 162 is hexagonal; however, it should be appreciated that the head may comprise any geometry suitable for applying torque to connector body 140. It should also be noted that, in an exemplary embodiment, connector body 140 may also be used for an inline connection within a line set. Another component in which fluid connection assembly 110, specifically connector body 140, may be installed into is an engine block. It should be appreciated that fluid connection assembly 110 may be used in various other components, assemblies, and subassemblies in which fluid connection is desired. In an exemplary embodiment, connector body 140 comprises at least one of a metal, a polymer, and a ceramic.

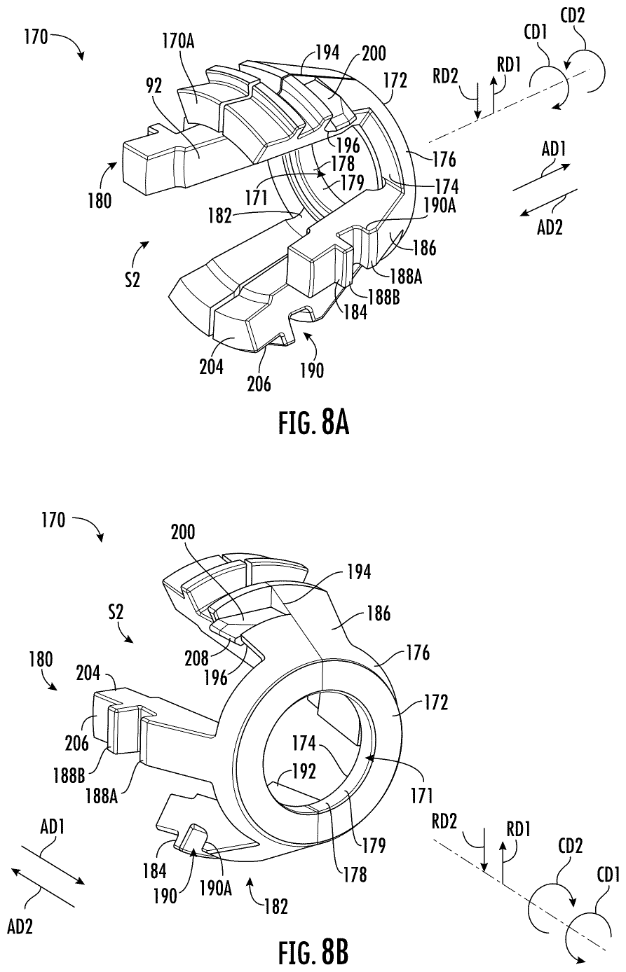

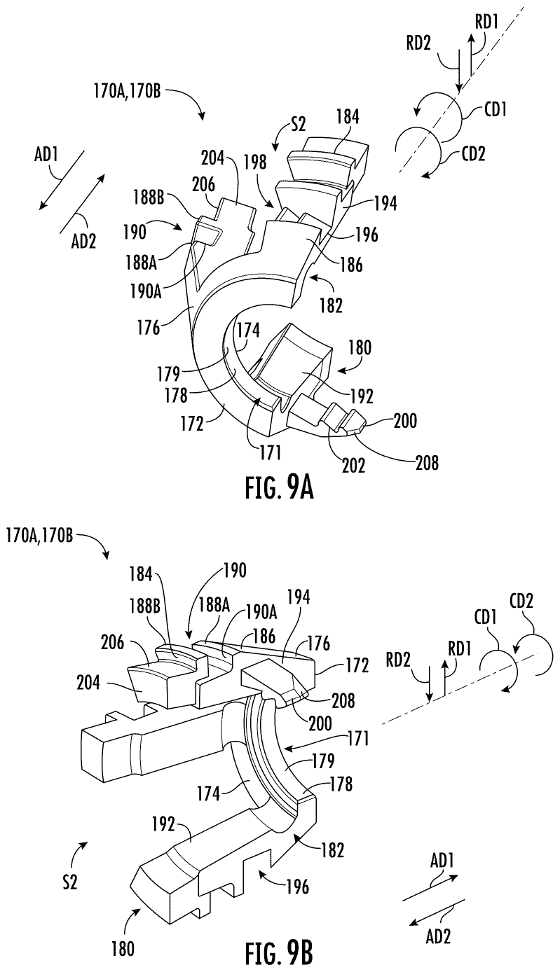

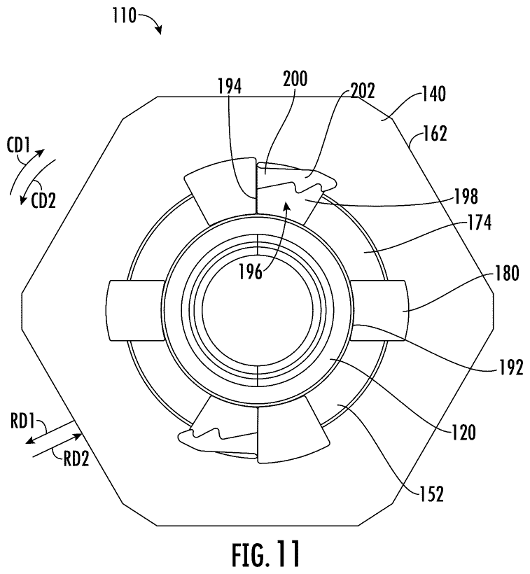

FIG. 8A is a front perspective view of retainer 170. FIG. 8B is a rear perspective view of retainer 170. FIG. 9A is a rear perspective view of retainer section 170A, 170B. FIG. 9B is a front perspective view of retainer section 170A, 170B. FIG. 10 is a cross-sectional view of fluid connection assembly 110 taken generally along line 10-10 in FIG. 6. FIG. 11 is a cross-sectional view of fluid connection assembly 110 taken generally along line 11-11 in FIG. 6. Retainer 170 is operatively arranged to be removably connected to connector body 140 and comprises end 172, end or surface 174, through-bore 171, radially outward facing surface 176, radially inward facing surface 178, and one or more fingers 180.

End 172 comprises an axial surface facing generally in axial direction AD1. End 172 is operatively arranged to engage or be arranged proximate to surface 154 when retainer 170 is connected to connector body 140. In an exemplary embodiment, and as shown, radially outward facing surface 176 is a frusto-conical surface extending radially outward in axial direction AD2. Radially outward facing surface 176 may correspond to radially outward facing surface 186, forming a single frusto-conical surface arranged at angle α with respect to radially inward facing surface 178. In an exemplary embodiment, radially inward facing surface 178 comprises a constant diameter and forms flange 179 arranged to engage groove 124 to secure tube 120 to connector body 140. Specifically, when tube 120 is secured to connector body 140 by retainer 170, surface 172 is arranged to engage or proximate to surface 126A, surface 174 is arranged to engage or proximate to surface 126B, and radially inward facing surface 178 is arranged to engage or proximate to radially outward facing surface 126C.

Each of fingers 180 comprises end 182 connected to end 174, end 184, radially outward facing surface 186, and radially inward facing surface 192. In an exemplary embodiment, and as shown, radially outward facing surface 186 is a frusto-conical surface extending radially outward in axial direction AD2. Radially outward facing surface 186 is arranged at angle α with respect to radially inward facing surface 178. In an exemplary embodiment, angle α is an acute angle, for example, 25 degrees. When retainer 170 is connected to connector body 140, radially outward facing surface 186 and/or radially outward facing surface 176 is arranged to engage or proximate to radially inward facing surface 152. The engagement of radially outward facing surface 176, 186 with radially inward facing surface 152 and/or end 172 with surface 154 prevents axial displacement of retainer 170 in direction AD1 with respect to connector body 140. Moreover, the frusto-conical nature of corresponding surface 152 and surface 176, 186 facilitates alignment and connection of retainer 170 as it is being connected to connector body 140. In an exemplary embodiment, and as shown, ends 182 comprise a recess or groove extending radially outward from radially inward facing surface 192. This recess or groove promotes the elastic displacement of fingers 180 for the purposes of connecting and disconnecting retainer 170 with connector body 140.

In an exemplary embodiment, finger 180 further comprises radially outward facing surface 188A and/or radially outward facing surface 188B. Radially outward facing surface 188A comprises a constant diameter and is connected to radially outward facing surface 186. Radially outward facing surface 188B comprises a constant diameter and is connected to end 184. In an exemplary embodiment, the diameter of radially outward facing surface 188B is greater than the diameter of radially outward facing surface 188A. Finger 180 further comprises groove 190. Groove 190 is an annular groove extending radially inward into finger 180. In an exemplary embodiment, and as shown, groove 190 is axially arranged between radially outward facing surface 188A and radially outward facing surface 188B. However, it should be appreciated that, in an exemplary embodiment, groove 190 is arranged in radially outward facing surface 186. Groove 190 forms surface 190A, which is operatively arranged to engage surface 150A when retainer 170 is connected to connector body 140. In an exemplary embodiment, surface 190A is an axial surface facing substantially in axial direction AD2.

Radially inward facing surface 192 is a frusto-conical surface extending radially outward in axial direction AD2. Radially inward facing surface 192 is arranged at angle β with respect to radially inward facing surface 178, or radially outward facing surface 124 of tube 120. In an exemplary embodiment, angle ρ is an acute angle, for example, 8 degrees. In an exemplary embodiment, angle α is greater than angle β. The frusto-conical nature of radially inward facing surface 192 results in a radial space being arranged between fingers 180 and tube 120. This space allows fingers 180 to be displaced radially inward in radial direction RD2 to disengage surfaces 190A from surfaces 150A, such that retainer 170, and tube 120, can be removed from connector body 140.

Fingers 180 are circumferentially spaced apart, for example, by spaces S2. In an exemplary embodiment, retainer 170 comprises a plurality of fingers 180, for example four fingers 180. As previously described, fingers 180 facilitate the removal of retainer 170 from connector body. For example, a user may displace fingers 180, via ends 184 and/or radially outward facing surfaces 188B, radially inward to disengage surfaces 190A from surface 150A, at which point retainer 170 can be removed from connector body 140. In an exemplary embodiment, one or more of fingers 180 comprises protrusion 204 which extends from end 184 in axial direction AD2. Protrusion 204 forms radially outward facing surface 206. In an exemplary embodiment, the diameter of radially outward facing surface 206 is less than the diameter of radially outward facing surface 188B. As such, protrusion 204 can easily be located and used as a engagement position for connecting and disconnecting retainer 170 with connector body 140. Specifically, protrusions 204 are displaced radially inward to disengage surfaces 190A from surface 150A (i.e., a user can pinch retainer 170 about radially outward facing surfaces 206). In an exemplary embodiment radially outward facing surface 206 is a frusto-conical surface increasing in diameter in axial direction AD2.

In an exemplary embodiment, retainer 170 comprises a plurality of sections, for example, section 170A and section 170B. In an exemplary embodiment, section 170A and section 170B are substantially the same and thus are described herein as having substantially the same components. In addition to the elements described above, section 170A, 170B comprises planar surface 194, hole 196, and protrusion 200. As shown, retainer 170 is substantially split in half at surface 194. Specifically, section 170A is mated to section 170B at respective surfaces 194. Protrusion 200 of section 170A is arranged to engage hole 196 of section 170B and protrusion 200 of section 170B is arranged to engage hole 196 of section 170A.

Hole 196 extends from surface 194 to space S2. Hole 196 forms a radially outward facing surface on section 170A, 170B, on which one or more teeth 198 are arranged. Protrusion 200 comprises one or more teeth 202. When sections 170A and 170B are connected to form retainer 170, surfaces 194 of sections 170A-170B are engaged, protrusions 200 extend at least partially through respective holes 196, and teeth 202 at least partially engage teeth 198 thereby preventing disconnection of section 170B from section 170A. In an exemplary embodiment, protrusion 200 further comprises tapered surface 208. Tapered surface 208 facilitates alignment and connection of sections 170A-170B as protrusions 200 are being inserted into respective holes 196.

In an exemplary embodiment, each of sections 170A-170B comprises a plurality of fingers 180, for example three fingers 180. A first finger 180 comprises protrusion 200 and a second finger 180 comprises hole 196. A third finger 180 is arranged circumferentially between and spaced apart from the first finger 180 and the second finger 180. When sections 170A-170B are connected, the first finger 180 of section 170A abuts the second finger of section 170B, and the second finger of section 170A abuts the first finger of section 170B. Thus, it could be said that retainer 170 comprises six fingers, or four circumferentially spaced fingers.

To assemble fluid connection assembly 110, section 170A and section 170B are arranged about tube 120 such that radially inward facing surfaces 178 are substantially aligned with radially outward facing surface 126C and protrusions 200 are aligned with holes 196. Section 170B is connected to section 170A around tube 120. Specifically, and as previously described, protrusions 200 are engaged with respective holes 196 until teeth 202 engage respective teeth 198. Radially inward facing surface 178 is engaged with groove 126, and tube 120 extends through retainer 170. In an exemplary embodiment, seals 138A-138B are arranged in grooves 128A-128B. Tube 120, with retainer 170 arranged thereon, is then inserted, with end 122 first into connector body 140 in axial direction AD1 until section 134 engages radially inward facing surface 158, end 172 engages surface 154, and/or radially outward facing surface 176, 186 engages radially inward facing surface 152. The engagement of radially outward facing surface 186 with radially inward facing surface 148 forces fingers 180 radially inward until surface 190A aligns with groove 150, at which point fingers 180 snap back radially outward to their original position. Surface 190A is then engaged with surface 150A to prevent displacement of retainer 170 in axial direction AD2 with respect to connector body 140.

To disassemble fluid connection assembly 110, fingers 180 are displaced radially inward, such that angle β is decreased, until surfaces 190A disengage surface 150A. Retainer 170 and tube 120 may then be removed from connector body 140. If desired, retainer 170 can be removed from tube 120, for example by displacing protrusions 200 to disengage teeth 202 from respective teeth 198, at which point section 170B can be removed from section 170A.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

REFERENCE NUMERALS

| | |
|---|---|
| 10 | Fluid connection assembly |
| 20 | Tube |
| 22 | End |
| 24 | Radially outward facing surface |
| 26 | Groove |
| 26A | Surface |
| 26B | Surface |
| 26C | Radially outward facing surface |
| 28A | Groove |
| 28B | Groove |
| 30 | End |
| 32 | Through-bore |
| 34 | Section |
| 36 | Section |
| 38A | Seal |
| 38B | Seal |
| 40 | Connector body |
| 41 | Through-bore |
| 42 | End |
| 44 | End |
| 46 | Radially inward facing surface |
| 48 | Radially inward facing surface |
| 50 | Groove |
| 50A | Surface |
| 52 | Radially inward facing surface |
| 54 | Surface |
| 56 | Radially inward facing surface |
| 58 | Radially inward facing surface |
| 60 | Radially outward facing surface |
| 62 | Head |
| 64 | Radially outward facing surface |
| 70 | Retainer |
| 70A | Section |
| 70B | Section |
| 71 | Through-bore |
| 72 | End |
| 74 | End |
| 76 | Radially outward facing surface |
| 78 | Radially inward facing surface |
| 79 | Flange |
| 80 | Fingers |
| 82 | End |
| 84 | End |
| 86 | Radially outward facing surface |
| 88A | Radially outward facing surface |
| 88B | Radially outward facing surface |
| 90 | Groove |
| 90A | Surface |
| 92 | Radially inward facing surface |
| 94 | Surface |
| 96 | Surface |
| 98 | Hole |
| 100 | Protrusion |
| 102 | Shoulder |
| 104 | Surface |
| 110 | Fluid connection assembly |
| 120 | Tube |
| 122 | End |
| 124 | Radially outward facing surface |
| 126 | Groove |
| 126A | Surface |
| 126B | Surface |
| 126C | Radially outward facing surface |
| 128A | Groove |
| 128B | Groove |
| 130 | End |
| 132 | Through-bore |
| 134 | Section |
| 136 | Section |
| 138A | Seal |
| 138B | Seal |
| 140 | Connector body |
| 141 | Through-bore |
| 142 | End |
| 144 | End |
| 146 | Radially inward facing surface |
| 148 | Radially inward facing surface |
| 150 | Groove |
| 150A | Surface |
| 152 | Radially inward facing surface |
| 154 | Surface |
| 156 | Radially inward facing surface |
| 158 | Radially inward facing surface |
| 160 | Radially outward facing surface |
| 162 | Head |
| 164 | Radially outward facing surface |
| 170 | Retainer |
| 170A | Section |
| 170B | Section |
| 171 | Through-bore |
| 172 | End |
| 174 | End |
| 176 | Radially outward facing surface |
| 178 | Radially inward facing surface |
| 179 | Flange |
| 180 | Fingers |
| 182 | End |
| 184 | End |
| 186 | Radially outward facing surface |
| 188A | Radially outward facing surface |
| 188B | Radially outward facing surface |
| 190 | Groove |
| 190A | Surface |
| 192 | Radially inward facing surface |
| 194 | Surface |
| 196 | Hole or surface |
| 198 | Teeth |
| 200 | Protrusion |
| 202 | Teeth |
| 204 | Protrusion |
| 206 | Radially outward facing surface |
| 208 | Tapered surface |
| 210 | Seal |
| AD1 | Axial direction |
| AD2 | Axial direction |
| CD1 | Circumferential direction |
| CD2 | Circumferential direction |
| RD1 | Radial direction |
| RD2 | Radial direction |
| S1 | Space |
| S2 | Space |
| α | Angle |

1. A fluid connection assembly, comprising:
a connector body, including:
a first end;
a second end;
a first through-bore;
a first radially inward facing surface including a first groove forming a first axial surface; and
a first radially outward facing surface; and
a retainer removably connectable to the connector body, including:
a second radially inward facing surface forming a flange, a third end, and a fourth end;
a second radially outward facing surface;
a second through-bore;
at least one finger extending from the fourth end; and
a second axial surface operatively arranged to engage the first axial surface to lock the retainer in the connector body.

2. The fluid connection assembly as recited in claim 1, wherein the at least one finger comprises:
a proximal end connected to the fourth end;
a distal end;
a third radially outward facing surface; and
a third radially inward facing surface, wherein the third radially inward facing surface is a frusto-conical surface arranged at an acute angle with respect to the second radially inward facing surface.

3. The fluid connection assembly as recited in claim 2, wherein a second groove is formed in the third radially outward facing surface, wherein the second groove forms the second axial surface.

4. The fluid connection assembly as recited in claim 2, wherein the distal end forms the second axial surface.

5. The fluid connection assembly as recited in claim 2, wherein at least one of the second radially outward facing surface and the third radially outward facing surface is a frusto-conical surface arranged at an acute angle with respect to the second radially inward facing surface.

6. The fluid connection assembly as recited in claim 2, wherein the third radially outward facing surface comprises:
a frusto-conical surface; and
at least one constant diameter surface.

7. The fluid connection assembly as recited in claim 6, wherein the at least one constant diameter surface comprises:
a first constant diameter surface; and
a second constant diameter surface, spaced apart from the first constant diameter surface.

8. The fluid connection assembly as recited in claim 7, wherein the second constant diameter surface is arranged at the distal end.

9. The fluid connection assembly as recited in claim 7, wherein:
the first constant diameter surface comprises a first diameter;
the second constant diameter surface comprises a second diameter; and
the second diameter is greater than the first diameter.

10. The fluid connection assembly as recited in claim 2, wherein the retainer comprises:
a first section including a first protrusion and a first hole; and
a second section including a second protrusion and a second hole, wherein the first protrusion and the second protrusion are operatively arranged to engage the first hole and the second hole, respectively, to connect the first section to the second section to form the retainer.

11. The fluid connection assembly as recited in claim 10, wherein at least one of the first protrusion and the second protrusion comprises at least one tooth.

12. The fluid connection assembly as recited in claim 2, further comprising a tube including a fourth radially outward facing surface comprising a second groove, wherein the flange is operatively arranged to engage the second groove to secure the tube in the connector body.

13. The fluid connection assembly as recited in claim 12, wherein the tube further comprises a third groove and a seal arranged therein.

14. The fluid connection assembly as recited in claim 12, wherein when the tube is secured to the connector body via the retainer, a radial space is arranged between the fourth radially outward facing surface and the third radially inward facing surface.

15. The retainer as recited in claim 1, wherein the at least one finger comprises a plurality of fingers circumferentially spaced about the fourth end.

16. A fluid connection assembly, comprising:
a connector body, including:
a first end;
a second end;
a first through-bore;
a first radially inward facing surface including a first groove forming a first axial surface; and
a first radially outward facing surface;
a retainer removably connectable to the connector body, including:
a second radially inward facing surface forming a flange, a third end, and a fourth end;
a second radially outward facing surface;
a second through-bore;
a plurality of fingers extending from and circumferentially spaced about the fourth end; and
a second axial surface operatively arranged to engage the first axial surface to lock the retainer in the connector body; and
a tube including a third radially outward facing surface comprising a second groove, wherein the flange is operatively arranged to engage the second groove to secure the tube in the connector body.

17. The fluid connection assembly as recited in claim 16, wherein each finger of the plurality of fingers comprises:
a proximal end connected to the fourth end;
a distal end;
a fourth radially outward facing surface; and
a third radially inward facing surface, wherein the third radially inward facing surface is a frusto-conical surface arranged at an acute angle with respect to the second radially inward facing surface.

18. The fluid connection assembly as recited in claim 17, wherein when the tube is secured to the connector body via the retainer, a radial space is arranged between the third radially outward facing surface and the third radially inward facing surface.

19. The fluid connection assembly as recited in claim 16, wherein the retainer comprises:
a first section including a first protrusion and a first hole; and
a second section including a second protrusion and a second hole, wherein the first protrusion and the second protrusion are operatively arranged to engage the first hole and the second hole, respectively, to connect the first section to the second section to form the retainer.

20. The fluid connection assembly as recited in claim 19, wherein at least one of the first protrusion and the second protrusion comprises at least one tooth.
